(19) United States
(12) Patent Application Publication
(10) Pub. No.: US 2017/0185962 A1
(43) Pub. Date: Jun. 29, 2017

(54) Construction Project Monitoring System and Method

(71) Applicant: Sammie D. Williams, Eastland, TX (US)

(72) Inventor: Sammie D. Williams, Eastland, TX (US)

(21) Appl. No.: 15/391,820

(22) Filed: Dec. 27, 2016

Related U.S. Application Data
(60) Provisional application No. 62/271,702, filed on Dec. 28, 2015.

(51) Int. Cl. G06Q 10/10; H04L 29/06; G06F 21/62; G06Q 20/10; G06F 17/30

(52) U.S. Cl. CPC G06Q 10/103; G06Q 20/102; G06F 17/30312; G06F 21/6245; H04L 63/105; G06F 21/6227; G06Q 50/08

(57) ABSTRACT

A construction project management system includes a secure database for storing construction project data and coupled to a global computer network, and a web server hosting a plurality of web pages. The plurality of web pages include logic configured for providing an authorized user associated with a construction company selective access to data stored in the secure database, computing financial data, and displaying construction project data in a concise manner. The web pages include a dashboard web page configured to display an activity feed section listing changes made by company personnel to the construction project data of the construction company stored in the secure database, a job management web page configured to provide access to financial and status information about construction jobs of the construction company stored in the secure database, and a privileges management web page configured to provide access to data access privilege settings of company personnel.

### RELATED APPLICATION

This patent application claims the benefit of U.S. Provisional Patent Application No. 62/271,702 filed Dec. 28, 2015.

### FIELD OF THE INVENTION

The present disclosure relates to the field of construction, and in particular to a construction project monitoring system and method.

### BACKGROUND

Construction projects tend to be seasonal in nature and many if not most construction companies rely on sub-contractors to perform the various trades that may be required for a given project. Many of these contractors and sub-contractors also rely on sales and management people who are compensated on a commission basis. A construction company, acting as a general contractor, must have a way to manage and keep track of multiple projects simultaneously by monitoring the progress, payments in and out, commissions and advance draws on commission by sales and management personnel, and labor, materials and inventory of each project. More importantly, the company must be able to monitor and have quick and easy access to the financial data, and determine the status or bottom line of each project.

### BRIEF DESCRIPTION OF THE DRAWINGS

FIG. 1 is a simplified block diagram of an exemplary embodiment of a construction project management system and method according to the teachings of the present disclosure;

FIG. 2 is another simplified block diagram illustrating the various users and user roles of an exemplary embodiment of a construction project management system and method according to the teachings of the present disclosure;

FIGS. 3-5 are block diagrams illustrating various concepts in an exemplary embodiment of a construction project management system and method according to the teachings of the present disclosure;

FIG. 6 is a simplified flowchart of an exemplary embodiment of a job entry process for the construction project management system and method according to the teachings of the present disclosure;

FIG. 7 is a simplified flowchart of an exemplary embodiment of a people entry process for the construction project management system and method according to the teachings of the present disclosure;

FIG. 8 is a simplified flowchart of an exemplary embodiment of a payment entry process for the construction project management system and method according to the teachings of the present disclosure;

FIG. 9 is a simplified flowchart of an exemplary embodiment of a dashboard process for the construction project management system and method according to the teachings of the present disclosure;

FIG. 10 is a simplified flowchart of an exemplary embodiment of a job management process for the construction project management system and method according to the teachings of the present disclosure;

FIG. 11 is a screen shot of an exemplary embodiment of a dashboard process for the construction project management system and method according to the teachings of the present disclosure;

FIG. 12 is a screen shot of an exemplary embodiment of a job listing for the construction project management system and method according to the teachings of the present disclosure;

FIG. 13 is a screen shot of an exemplary embodiment of a client management module for the construction project management system and method 10 according to the teachings of the present disclosure;

FIGS. 14A and 14B are screen shots of an exemplary embodiment of a job management module for the construction project management system and method according to the teachings of the present disclosure;

FIG. 15 is a screen shot of an exemplary embodiment of a job leads listing for the construction project management system and method according to the teachings of the present disclosure;

FIG. 16 is a screen shot of an exemplary embodiment of a client listing for the construction project management system and method according to the teachings of the present disclosure;

FIG. 17 is a screen shot of an exemplary embodiment of a people listing for the construction project management system and method according to the teachings of the present disclosure;

FIG. 18 is a screen shot of an exemplary embodiment of a people management module for the construction project management system and method according to the teachings of the present disclosure;

FIG. 19 is a screen shot of an exemplary embodiment of a vendor listing for the construction project management system and method according to the teachings of the present disclosure;

FIG. 20 is a screen shot of an exemplary embodiment of a payment listing for the construction project management system and method according to the teachings of the present disclosure;

FIG. 21 is a screen shot of an exemplary embodiment of an equity report listing for the construction project management system and method according to the teachings of the present disclosure;

FIG. 22 is a screen shot of an exemplary embodiment of a capped job listing for the construction project management system and method according to the teachings of the present disclosure;

FIG. 23 is a screen shot of an exemplary embodiment of a commission report listing for the construction project management system and method according to the teachings of the present disclosure;

FIG. 24 is a screen shot of an exemplary embodiment of a company profile management module for the construction project management system and method according to the teachings of the present disclosure;

FIG. 25 is a screen shot of an exemplary embodiment of a user listing for the construction project management system and method according to the teachings of the present disclosure;

FIG. 26 is a screen shot of an exemplary embodiment of a privileges module for the construction project management system and method according to the teachings of the present disclosure; and

FIG. 27 is a screen shot of a further exemplary embodiment of a privileges module for the construction project management system and method 10 according to the teachings of the present disclosure.

### DETAILED DESCRIPTION

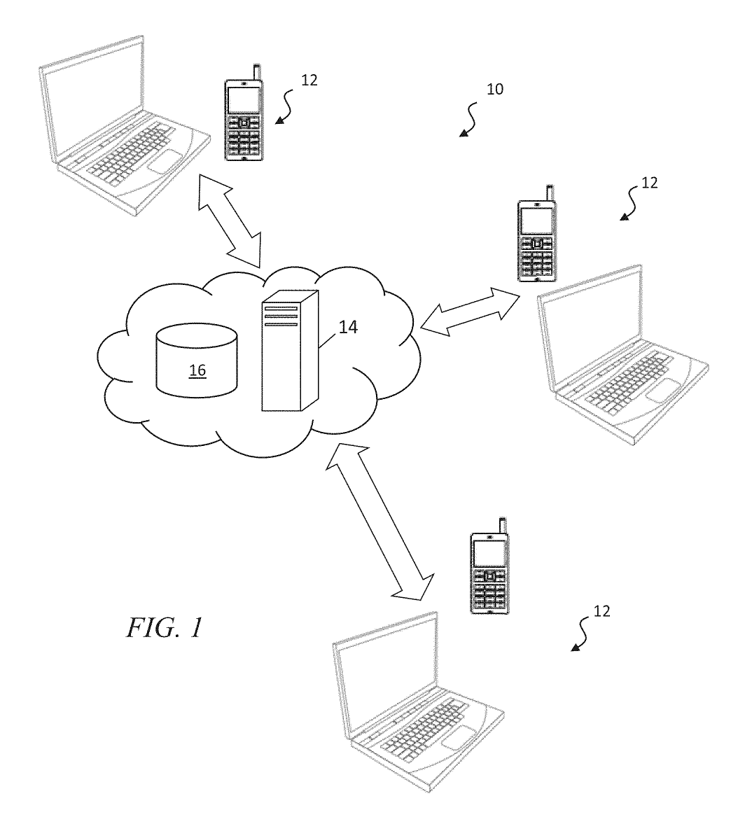

FIG. 1 is a simplified block diagram of an exemplary embodiment of a construction project management system and method 10 according to the teachings of the present disclosure. The construction project management system and method 10 are preferably a cloud-based system 10 that enable users to interface with the system via a web browser interface or another suitable user interface. The users may access the system and method 10 using any type of suitable computing device 12, such as desktop computers, laptop computers, mobile devices, wearable devices, etc. that enables the execution of a web browser program or another manner of interface/access. The system 10 includes at least one web server 14 that hosts a website including a plurality of web pages, in addition to software code and logic of the construction project management system and method 10, and at least one database 16 that stores all system data and client data, including information related to the construction company, company personnel, construction jobs, clients, payments, expenses, vendors, suppliers, and other data. The data may be encrypted and are protected from unauthorized access by one or more security measures now known or later to be developed, such as user name, password, and other measures. The database 16 may include one or more physical data storage devices that employ redundancy and load balancing technology to ensure optimal data access and storage by the users. The web server 14 and the database 16 may or may not be co-located and may be coupled via a computer network, which may be a Local Area Network, Wide Area Network, or the Internet.

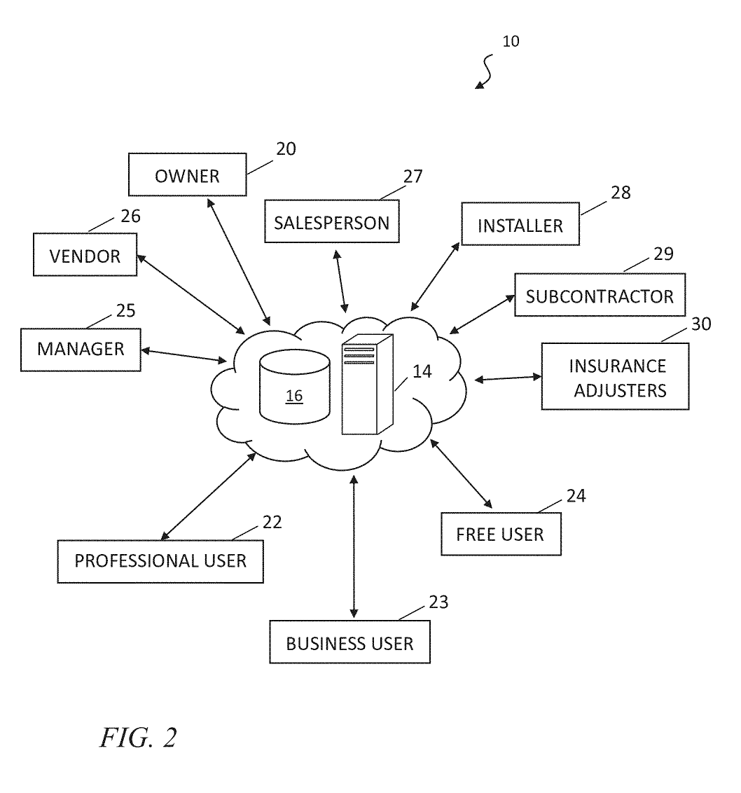

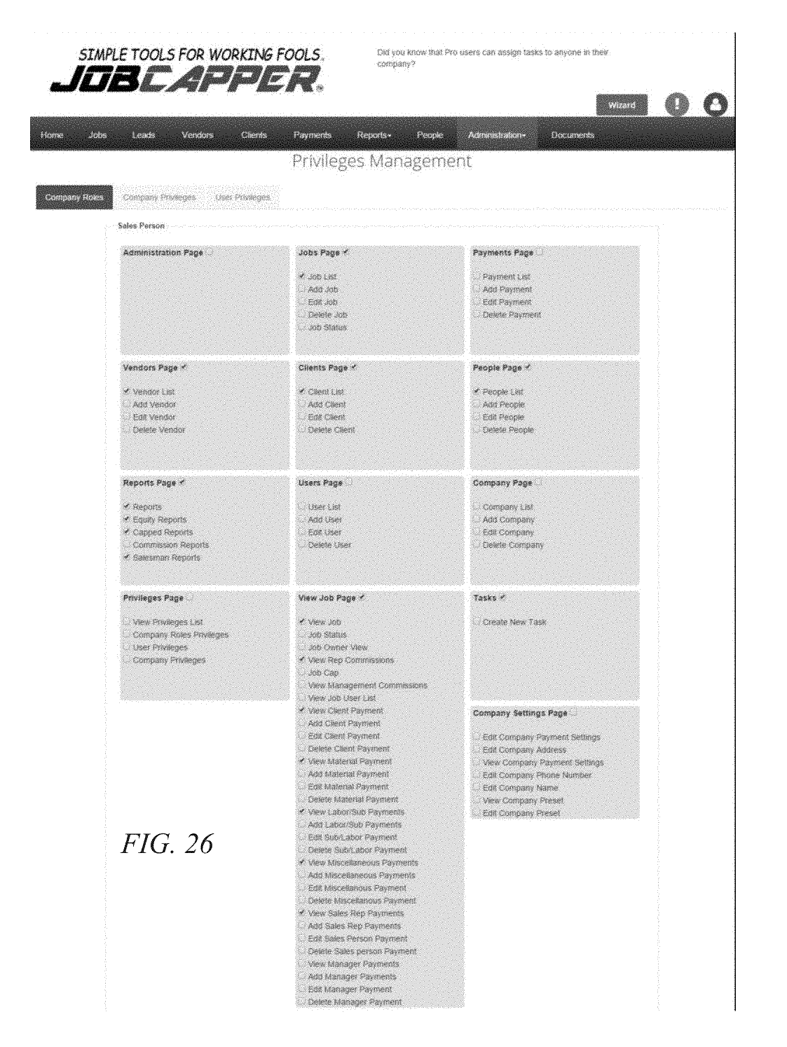

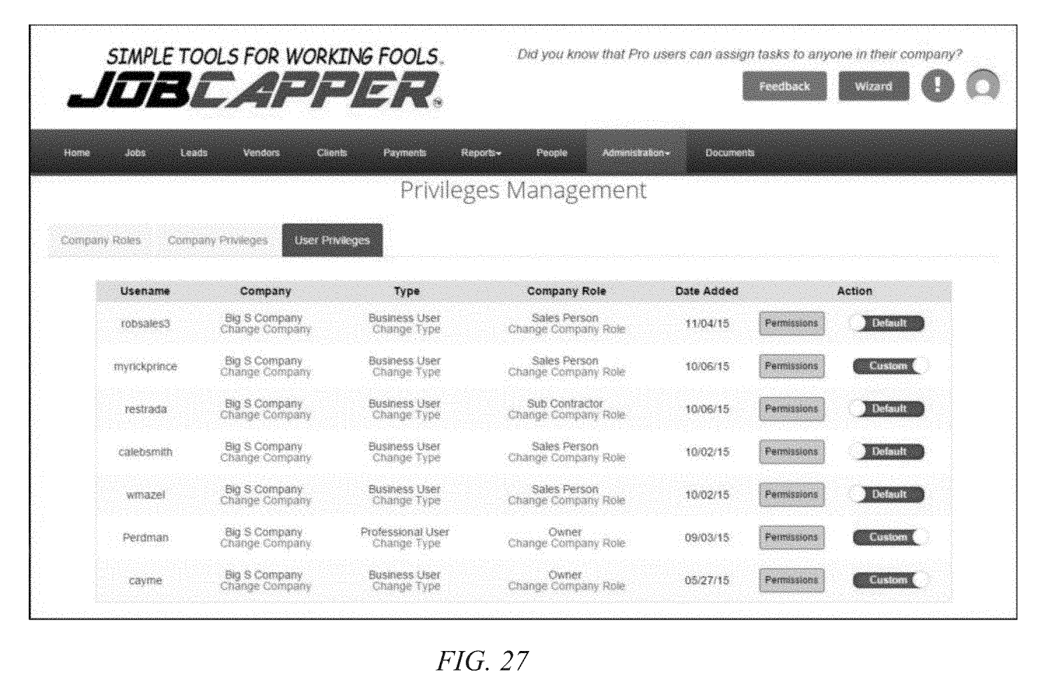

FIG. 2 is another simplified block diagram illustrating the various users and user roles of an exemplary embodiment of a construction project management system and method 10 according to the teachings of the present disclosure. The system and method 10 enable a top-level user, such as a construction company owner or executive (or a primary user of the company account) 20, to define a number of roles that others within the company or that work with the company can have in the system 10. The system 10 may have at least three types of users: professional users 22, business users 23, and free users 24. A professional user 22 is a user that has paid a top-level premium or subscription fee to use the system 10, and is typically the owner or an executive of a construction company that oversees the operations of the construction projects. The professional user 22 is typically assigned the “owner” role for the professional user account. The professional user 22 can assign or give a virtual “key” to his company personnel, including employees, sales managers and salespersons, independent contractors, and sub-contractors, so that they may have various levels of access to certain predetermined subsets of company data in the system 10. The term “company personnel” is used herein to refer to anyone who is associated with the company in some defined or assigned role. These company user roles may include managers 25, vendors 26, salesperson 27, installers 28, subcontractors 29, and insurance adjusters 30. The “owner” may easily specify the data that personnel assigned to each user role can access, such as shown in the exemplary screen shot in FIGS. 26 and 27 in which data access privileges are set. In order to be assigned a key to have access to the company data, the company personnel has to be a business user 23 of the system 10, which is a second level of paid user account.

A third level of user account is the free user 24. A free user 24 has provided enough information to the system 10 such as name and contact information to have login access to the system. A free user 24 may be new users who want to try out the system functions and be a searchable entity in the system 10. A free user 24 may be able to access a limited set of data, such as profile information of companies, vendors, and sub-contractors. The free user 24 may be upgraded to a business user or a professional user upon payment of a subscription fee.

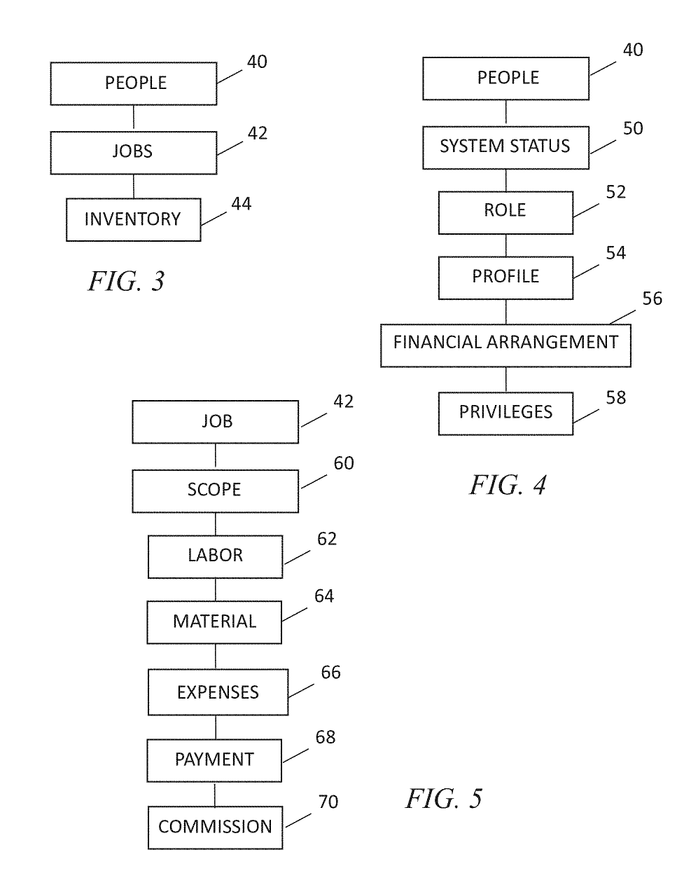

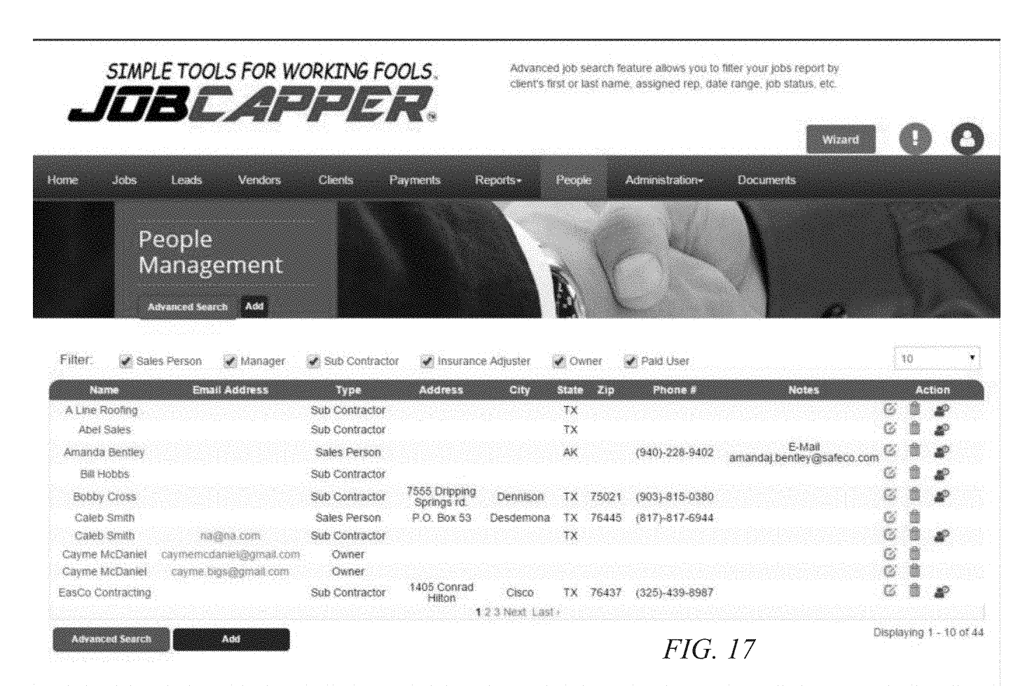

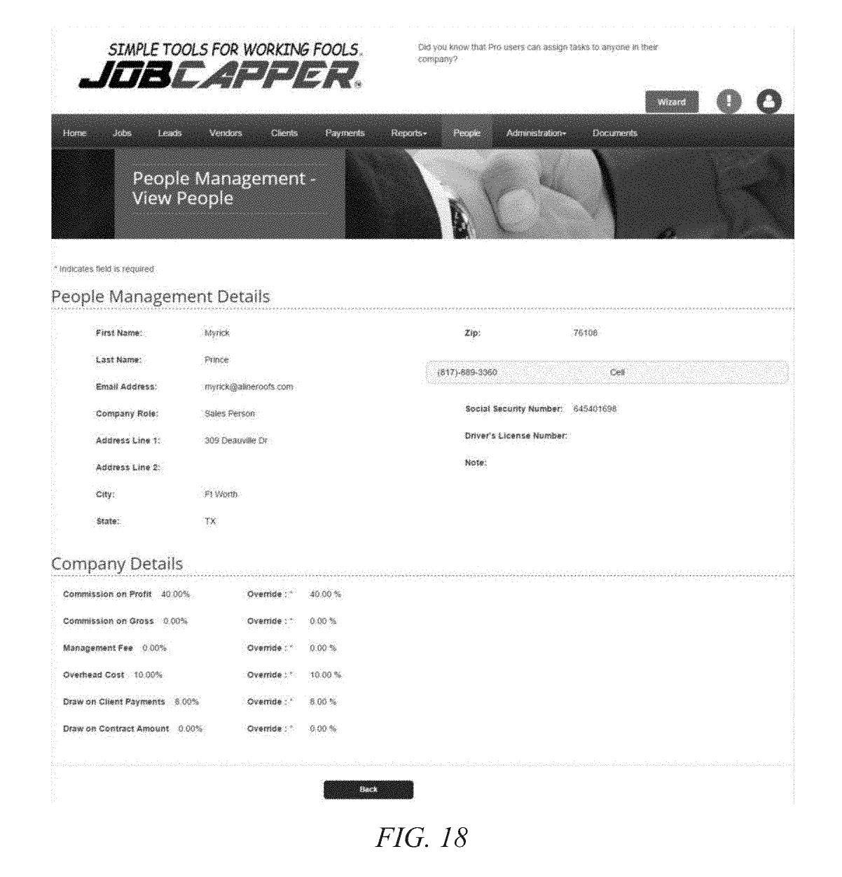

FIGS. 3-5 are block diagrams illustrating various concepts in an exemplary embodiment of a construction project management system and method 10 according to the teachings of the present disclosure. Referring to FIG. 3, the system and method 10 enable the “owner” or professional user the ability to manage three entities: people 40, jobs 42, and inventory 44 associated with the construction company. People 40 may be managers 24, vendors 25, salesperson 26, installers 27, subcontractors 28, and insurance adjusters 29 who are on staff (employed and contracted) with the company or people who are associated with one or more construction projects. Jobs 42 are construction projects for which the construction company has been hired. Each job 42 is associated with a client name (owner of the property), address, sales person name, contracted amount, payments, expenses, commissions, and other data that the construction company account owner uses the system 10 to manage and keep track of. FIG. 17 is an exemplary screen shot of a primary web page for the people management module. The system and method 10 further help the construction company owner to keep track and manage inventory 44. Inventory 44 represents materials that has been purchased or sourced for the construction jobs 42. Further details of these managed entities are provided below.

Referring to FIG. 4, the system and method 10 includes a people management module 40 that enables the owner of the construction company account to manage and account for people associated with the company. FIG. 18 shows an exemplary screen shot of a people management page. Each person in the system may include a system status 50, e.g., free user, business user, or professional user. Each person may also include an assigned role 52, e.g., manager, vendor, owner, salesperson, installer, sub-contractor, and insurance adjuster. A person may be assigned one or more roles within the system. For example, a sales person may also serve as a manager. Each person also includes a profile 54 that includes the basic information of that person, such as name, address, telephone number, etc. For personnel who are compensated by the company on a commission basis, such as sales people and managers, the agreed upon financial arrangement 56 is also noted in the system 10. The financial arrangement is shown under the heading “Company Details” on the exemplary screen shot in FIG. 18. Further, each person also has assigned privileges 58 depending on their role(s) with respect to the construction company. Each person may be assigned default privileges defined for the role, or customized privileges that the owner of the company account may assign. FIG. 26 shows an exemplary screen shot of a web page on which an owner may set the default privileges for a sales person for each web page.

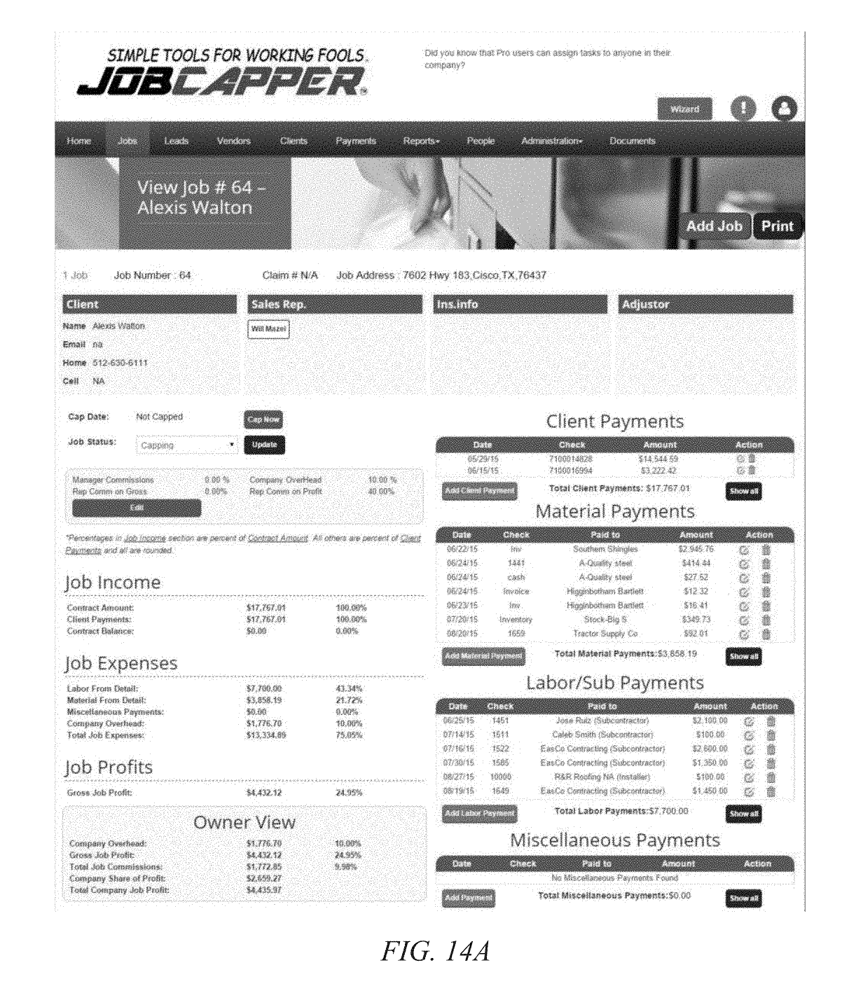

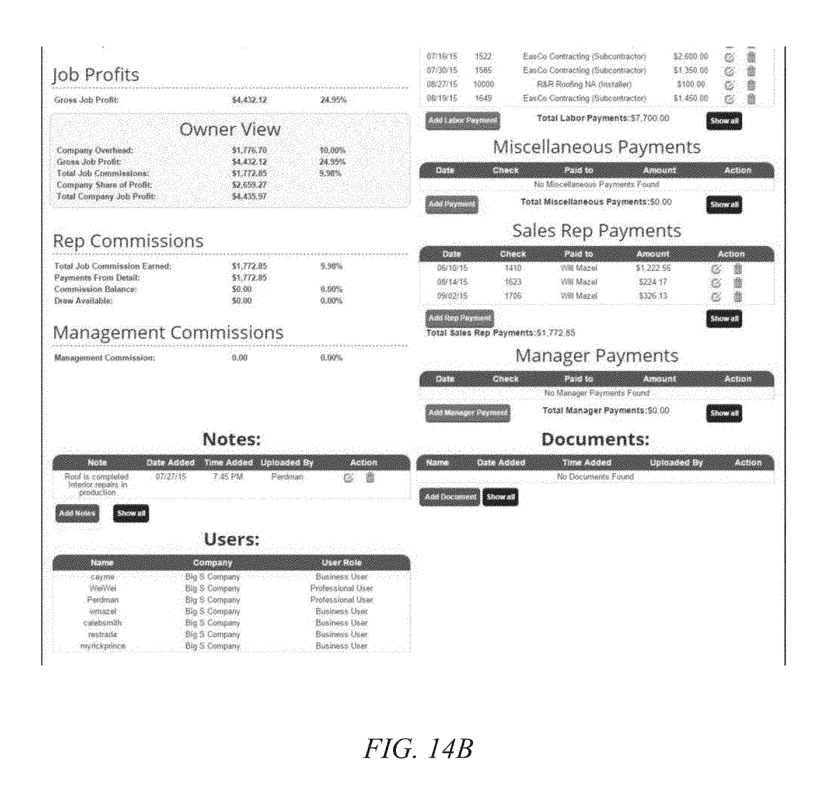

Referring to FIG. 5, the system and method 10 includes a job management module 42 that enables the owner of the construction company account to monitor all aspects of a construction project. FIGS. 14A and 14B show an exemplary screen shot of a job management screen. Each job 42 includes a definition of the scope 60 of the project, and the type and quantity of the labor 62 and materials 64 needed to complete the job. Further, the job may include additional expenses 66 other than the cost of labor and materials, such as permitting fees. The job management module 42 also records and keeps track of all incoming and outgoing payments 68 associated with the job, as well as commissions 70 promised and paid for the job.

Additionally, a job 42 may be assigned a status, which may include lead, job contract, supplementing, in production, final invoiced, capping, capped, etc. A job with a “lead” status means that a salesperson, manager, or the company has received a lead about a client who has a construction job that requires follow-up. A job 42 with a “job contract” status means that the client has signed a contract with the company to work on the construction project. A job with “supplementing” as the job status means the job has a charge or charges that need to be added to an insurance claim for items omitted, overlooked, under-paid, or discovered after the work began. A job that is “in production” means that work is on-going for this job. A job that has “final invoiced” as its status means that the job has been completed, the invoice has been submitted to the client, and payment is expected. A job with “capping” as the status means that payments have been received for the construction project, and the job is awaiting final accounting of all payments and expenses, including payment of commissions. Finally, a job that is “capped” means that final accounting of all invoices and payments have been handled so that the job is officially completed.

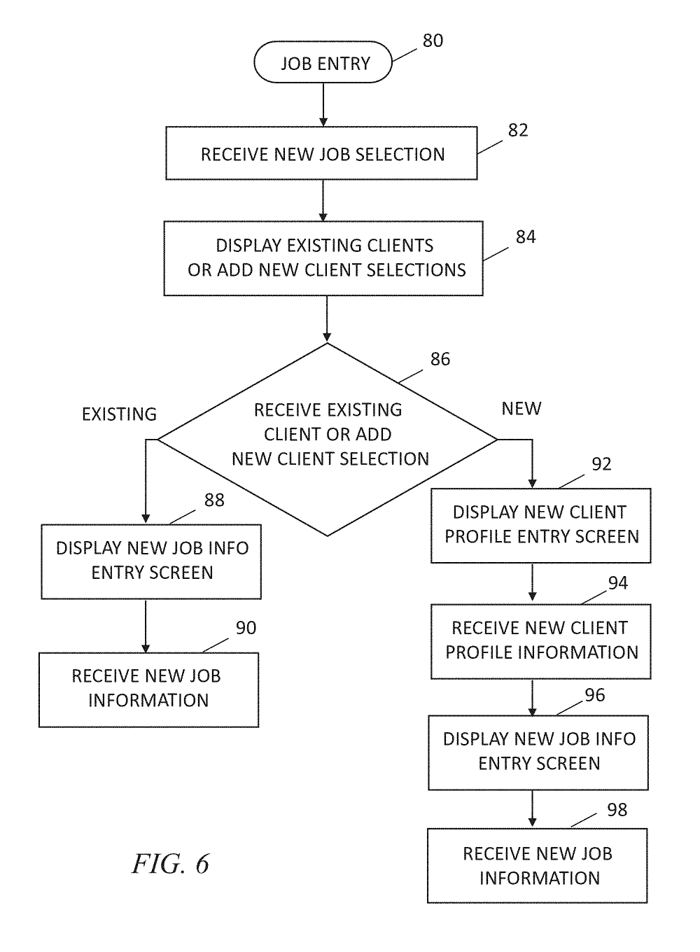

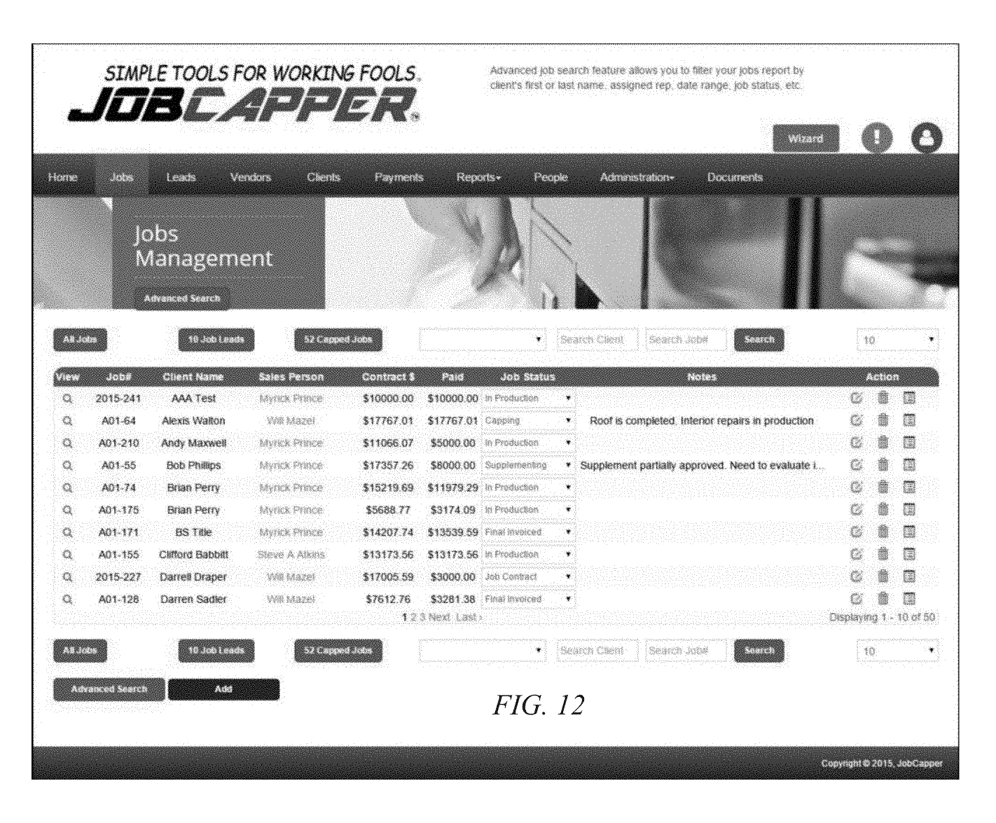

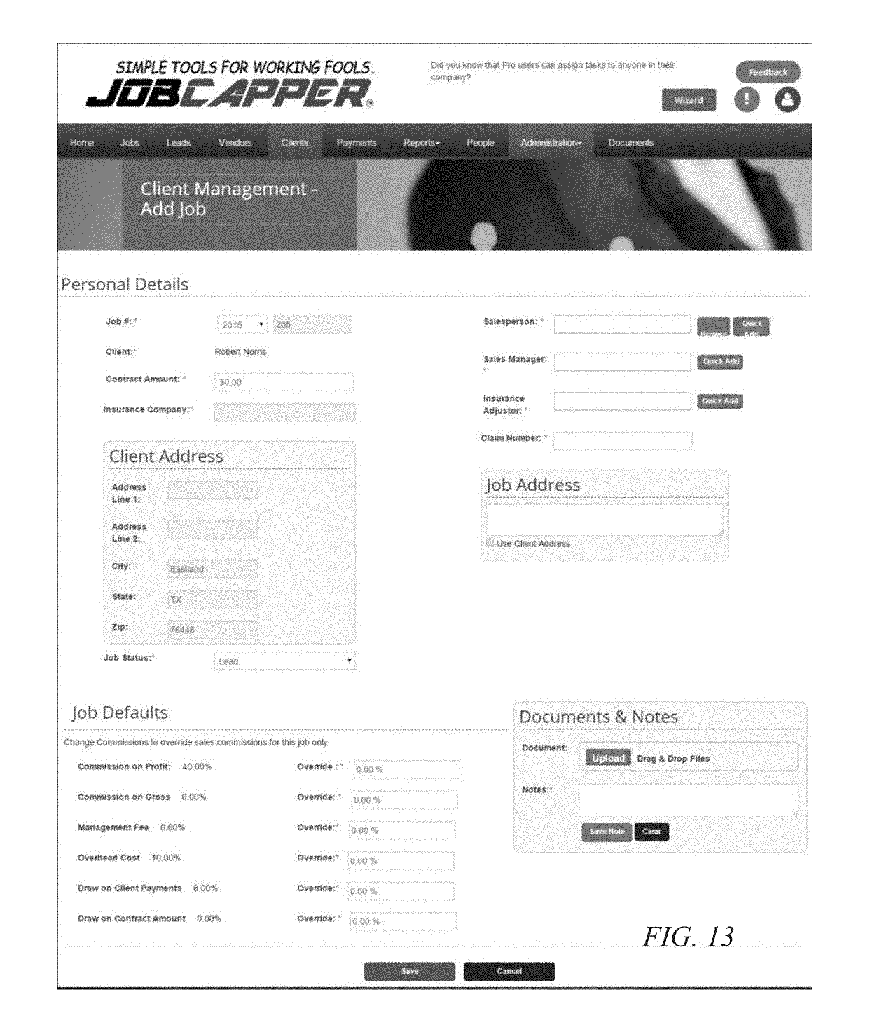

FIG. 6 is a simplified flowchart of an exemplary embodiment of a job entry process 80 for the construction project management system and method 10 according to the teachings of the present disclosure. A user may select a Job option, which leads to a list of current jobs. An exemplary screen shot of this job listing for the job management module is shown in FIG. 12. As shown in FIG. 12, an “Add” icon is displayed that enables the user to begin the entry of data associated with a new job. Upon receiving the user's indication of his/her desire to enter information for a new job, the system 10 inquires whether the job is associated with a new client or an existing client, as shown in blocks 82-86. In block 86, the user's selection is received. If the user selects an existing client from among a displayed list of clients, then a new job information entry screen is displayed with data fields to receive the user's input about the new job for the selected client, as shown in blocks 88 and 90. An exemplary job information entry screen for an existing client is shown in FIG. 13. The information entered for a new job includes: contract amount, insurance company, client address (data fields may be pre-populated if known), job address, salesperson name, sales manager name, insurance adjustor name, claim number, default commissions (financial arrangement) for the job with override capability, documents, and notes. If the user selects new client, then a new client information entry screen is displayed to receive new client information, as shown in blocks 92 and 94. Then new job information entry screen is displayed to receive data related to the new job for a new client, which also includes contract amount, insurance company, client address, job address, salesperson name, sales manager name, insurance adjustor name, claim number, default commissions for the job with override capability, documents, and notes, as shown in blocks 96 and 98. Accordingly, the system and method 10 receive the new job information from the user and store the data in the database 16.

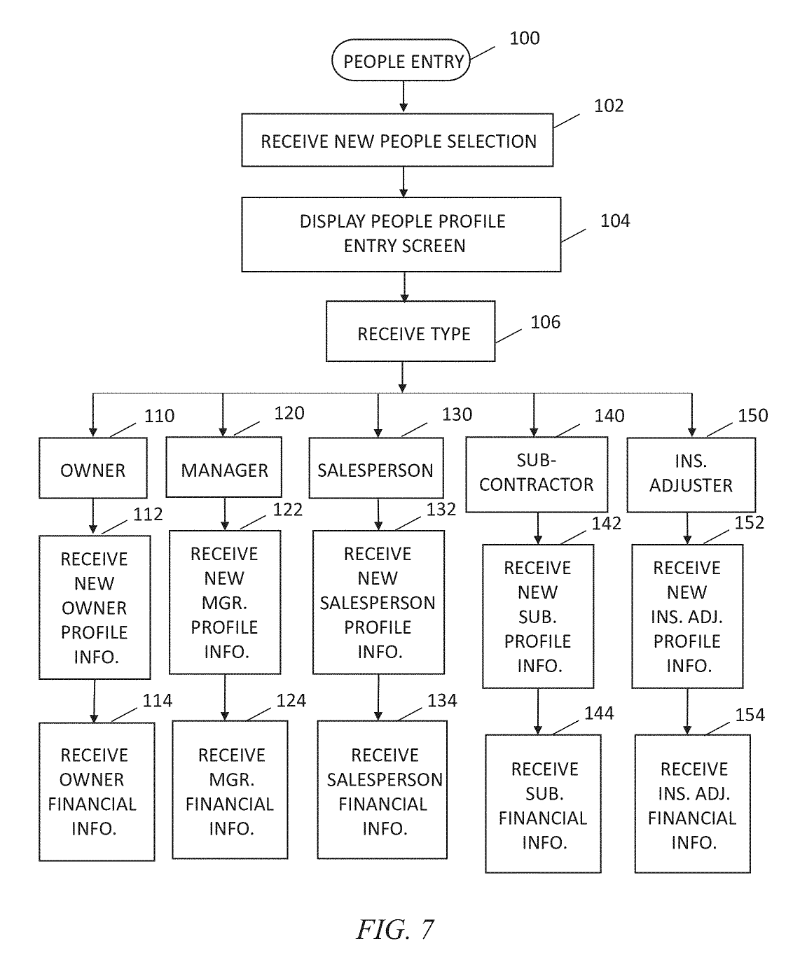

FIG. 7 is a simplified flowchart of an exemplary embodiment of a people entry process 100 for the construction project management system and method 10 according to the teachings of the present disclosure. A user may select a People Management option, which leads to a displayed list of people who are associated with the company. An exemplary screen shot of this people listing for the people management module is shown in FIG. 17. Upon receiving an indication from the user that new people information entry is desired, the people profile entry screen is displayed, as shown in blocks 102 and 104. The user then enters the role type for the new person to be added, as shown in block 106. The user may indicate the role of the person by selecting a drop-down list that provides selectable options. Upon an indication of the type of role, such as owner 110, manager 120, salesperson 130, sub-contractor 140, and insurance adjuster 150, for example, the user may then enter profile information of the person, and received as shown in blocks 112, 122, 132, 142, and 152. The basic people profile entry screen may include data fields for receiving information such as first name, last name, email address, address, and telephone number. Additional data fields may receive information that include the social security number, and driver license number. Further, additional entry fields are used to receive the company's agreed upon financial arrangement with the new person, as shown in blocks 114, 124, 134, 144, and 154. The new person and the company may agree on the commission percentage or amount, how commission is computed (on profit or gross), management fee, and whether the draw is from received client payment and/or contract amount. Accordingly, the system and method 10 receive the profile and financial information from the user and store the data in the database 16. An exemplary screen shot of a people management module displaying the information associated with a person is shown in FIG. 18.

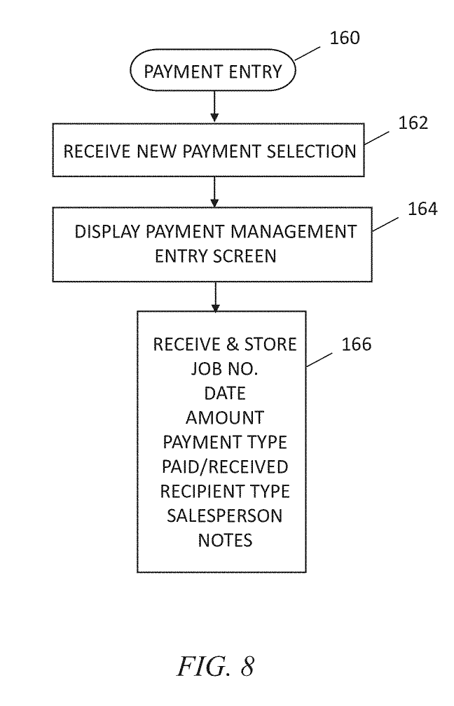

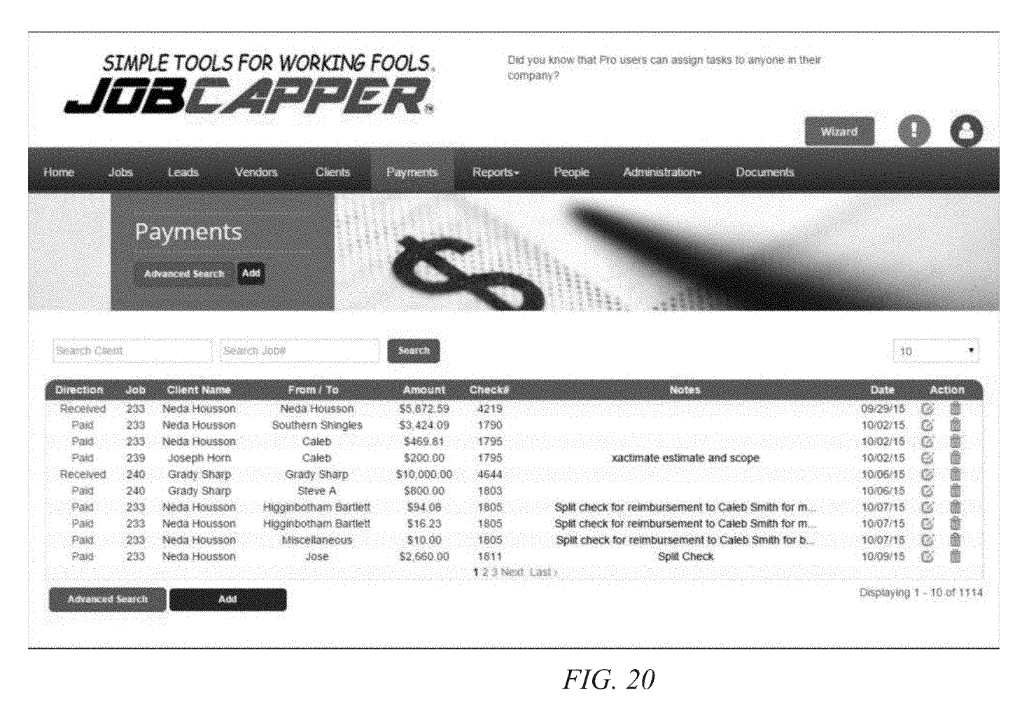

FIG. 8 is a simplified flowchart of an exemplary embodiment of a payment entry process 160 for the construction project management system and method according to the teachings of the present disclosure. An exemplary Payment management screen is shown in FIG. 20. In block 162, the system and method 10 receives the user's selection for a user to enter one or more new payments into the system. The payment management entry screen is then displayed to receive user input, as shown in block 164. The payment management entry screen displays data fields to receive data associated with the payment, which may include job number, date, amount, payment type (e.g., check, credit, cash, bank transfer, or other), payment received or paid, recipient type (e.g., salesperson, manager, sub-contractor, vendor, insurance adjuster, or other), salesperson name, and notes, as shown in block 166. The system and method 10 then associates the received data with the correct job and stores the data in the database 16. Accordingly, each payment in or out of the system 10 is associated in the database with a particular construction project or job.

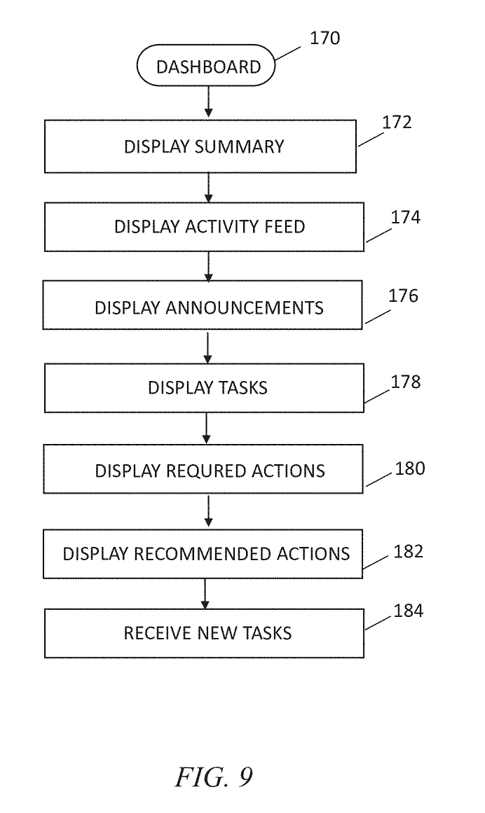

FIG. 9 is a simplified flowchart of an exemplary embodiment of a dashboard process 170 for the construction project management system and method 10 according to the teachings of the present disclosure. The dashboard page may be the first web page the user sees after logging into the system. FIG. 11 shows an exemplary dashboard page. The dashboard process 170 displays a variety of data associated with the user in a clear and concise way so that the user may ascertain important information at a glance.

The dashboard screen displays a summary section, as shown in block 172. The summary section provides a numerical status for each of a plurality of activities. The summary section preferably provides, for example, the number of job leads, assigned tasks, pending handshakes, assigned jobs, and pending keys for that particular user logged into the system. A “job lead” is where a potential client has been identified and follow-up is needed. “Assigned task” is where a user, e.g., an owner, may send information to another user, e.g., a salesperson, about a task that needs attention. A “pending handshake” is a virtual connection made between users, such as a manager and a sub-contractor. “Assigned jobs” is a contracted job that has been assigned to a manager and/or salesperson who will oversee the construction project. A “pending key” is access to company data given by a professional user, e.g., an owner, to a business user, e.g., a manager, salesperson, vendor, or sub-contractor. Accordingly, the dashboard provides information on current or pending action items that may require prompt attention from the user.

The dashboard page may also display an activity feed that lists one or more selected activities that have taken place for one or more selected users or company personnel, as shown in block 174. For example, the activity feed may display the payments entered into the system, a new client added, a new job added, etc. associated with one or more selected user (company personnel). The dashboard screen also displays an announcement section, assigned tasks, required actions, and recommended actions, as shown in blocks 176-182 and FIG. 11. The user may also create one or more new tasks for other users via the dashboard, which is received by the system 10, as shown in block 184. Accordingly, the dashboard provides the user concise and current information that makes it easier for the user to do his/her job.

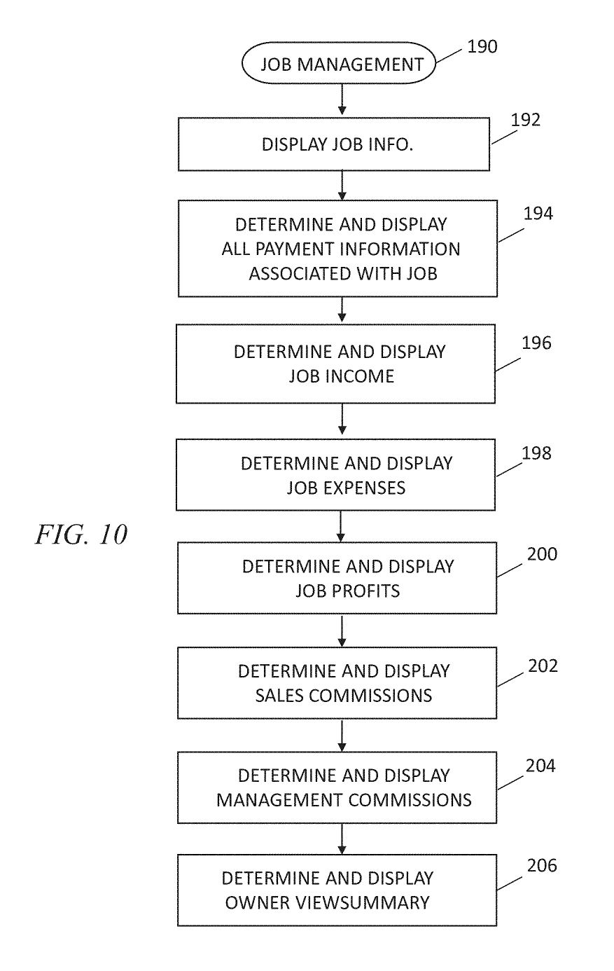

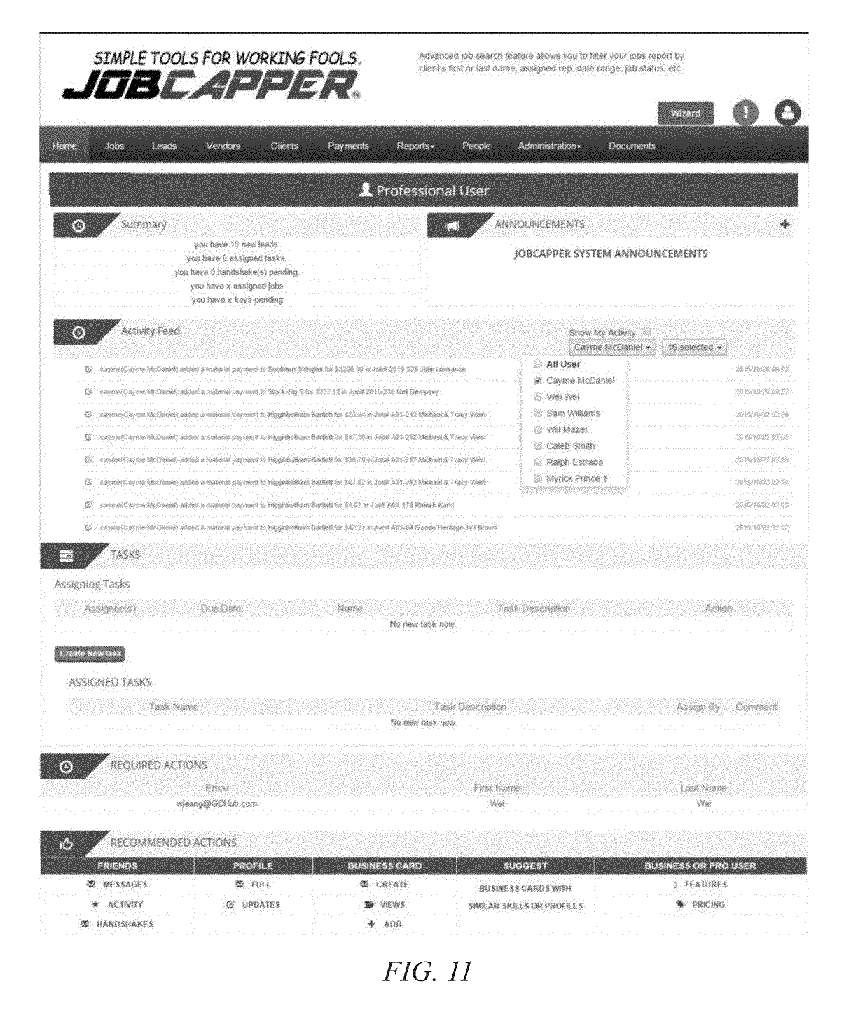

FIG. 10 is a simplified flowchart of an exemplary embodiment of a job management process 190 for the construction project management system and method 10 according to the teachings of the present disclosure. The user may select, from a list of active jobs, one particular job to view its detailed information. Reference also should be made to FIGS. 14A and 14B that show an exemplary job management web page in which detailed information is provided. The job management page provides a clear and concise view of all important financial information related to the construction job. The job management module accesses the database to pull the necessary financial data to perform calculations to populate the data fields on the page. Payment information, income, expenses, and profits are computed and populated on the page using data stored in the database 16.

The job management page displays job information including a job number (internally assigned by the system), client name, client address, job address, and contact information (e.g., email address and telephone numbers), as shown in block 192. The client address and the job address may be identical or different. Thereafter in block 194, the system and method 10 determine and display all payments, i.e., money coming in and going out, associated with this particular job. This includes all payments received from the property owner and insurance company as well as payments and commissions made to sub-contractors, managers, salespersons, vendors, etc. The system and method 10 also determine and display job “income” information, which includes the contracted amount and percentage for the job, payment amount and percentage from the client or property owner, and the remaining balance for the contract (contract amount minus client payment), as shown in block 196.

The expenses in amounts and percentages associated with this particular job are also determined and shown along with the total expense amount, as shown in block 198. Job expenses may include labor costs, material costs, miscellaneous costs, and company overhead. The system and method 10 further determine and display job gross profits, which is the amount and percentage of the job contract (and client payment) after all expenses have been subtracted, as shown in block 200. The system and method 10 further determine and display the commissions paid to the manager and salesperson(s), as shown in blocks 202 and 204. Further, if the user is an owner, an owner view information summary panel containing at-a-glance financial information of the job is also displayed, as shown in block 206. The owner view information panel may include the company overhead (amount and percentage), gross job profit (amount and percentage of total payment minus total expenses), total job commissions (amount and percentage), company share of the profit (gross job profit minus total job commissions), and total company job profit (company share of profit plus company overhead).

The job management page further includes a notes section that provides information on any notation any user recorded for the job. The job management page also includes a users section that lists all users or company personnel associated with this particular job. Further, the user may easily access images or copies of documents associated with this job, such as permits, blueprints, etc.

As set forth above, FIG. 11 is a screen shot of an exemplary embodiment of a dashboard process for the construction project management system and method 10 according to the teachings of the present disclosure. The dashboard provides a concise and clear at-one-glance view so that the user may quickly see a summary and an activity feed that lists activities that have taken place recently. The information collected and displayed on the dashboard is tailored to the particular user and his/her role that is logged in and accessing the system 10. The summary provided a tabulated quick view of the number of new leads, assigned tasks, handshakes, assigned jobs, and pending keys. As described above, a “new lead” is when a potential new client has been identified and follow-up is needed. An “assigned task” is where a user, e.g., an owner, may send information to another user, e.g., a salesperson, about a task that needs attention. A “pending handshake” is a virtual connection made between users, such as a manager and a sub-contractor. “Assigned jobs” is a contracted job that has been assigned to a manager and/or salesperson who will oversee the project. A pending key is access to company data given by a professional user, e.g., an owner, to a business user, e.g., a manager, salesperson, vendor, or sub-contractor. Accordingly, the dashboard page provides information tailored to the particular user on current or pending action items that may require prompt attention.

As shown in FIG. 11, the dashboard also collects and displays an activity feed that identifies a list of recent activities performed by company personnel. The user may selectively filter the activity feed with user name(s) and type(s) of activity. For example, the user may select one or more company personnel and one or more activities to view those specific activities performed by those specific users. The type of activity that can be selected may include: leads, handshakes, keys, assigned jobs, capped jobs, job status, person added, person edited, client add, client edit, client delete, user added, commission sales, commission jobs, commission company, job notes, job add, job edit, job delete, client payments, material payments, labor/sub payments, miscellaneous payments, rep payments, vendor, add document, edit document, and delete document. Therefore, for example, the user is able to call up all activities done by John Smith, any client and job edit done by Mary Jones, and all user edits done by any one or more users. This activity feed function is therefore also useful to monitor and audit company personnel activities.

FIG. 12 is a screen shot of an exemplary embodiment of a job listing for the construction project management system and method according to the teachings of the present disclosure. The job management module displays this initial page that provides basic information for a list of jobs. The displayed information may include job number, client name, salesperson responsible, contracted amount, paid amount, job status, and notes. The list is searchable by entering search criteria such as client name and job number in the search boxes. Advanced search is available for the user to submit additional search criteria to further refine the search scope. Additionally, the user may quickly display only capped jobs or job leads using dedicated search icons. The owner or professional user associated with the company account may have top-level edit privileges and can delete and edit certain jobs and/or data fields. From this job list, the user may click on a job number to access more detailed information about the selected job, and click on a salesperson name to access the profile information of the selected salesperson.

FIG. 13 is a screen shot of an exemplary embodiment of a client management module for the construction project management system and method 10 according to the teachings of the present disclosure. This particular example is a data entry page for a new job for an existing client in which some of the client information may be automatically populated, such as client name, address, and contact information. The user may additionally enter the contract amount, job address (may be the same as client address), insurance company information, salesperson and manager names, insurance adjuster name, and insurance claim number. Further, the user may add notes and copies of documents associated with this job. The user may also override the default commission percentages and how the payments are drawn set for this job.

FIGS. 14A and 14B are screen shots of an exemplary embodiment of a job management module for the construction project management system and method 10 according to the teachings of the present disclosure. The job management page provides important financial status and data for the selected construction job in a clear and concise manner. The job management page displays job information including a job number (internally assigned by the system), client name, client address, job address, and contact information (e.g., email address and telephone numbers). The client address and the job address may be identical or different. Further, the job management module determines and displays all payments in both directions, i.e., money coming in and going out, associated with the selected job. This includes all payments received from the property owner and insurance company as well as payments and commissions made to sub-contractors, managers, salespersons, vendors, etc. Job “income” information is also computed and displayed to provide information on the contracted amount and percentage, payment amount and percentage from the client or property owner, and the remaining balance for the contract (contract amount minus client payment). The expenses in amounts and percentages associated with this particular job are also determined and shown along with the total expense amount. Job expenses may include labor costs, material costs, miscellaneous costs, and company overhead. The job gross profits, which is the amount and percentage of the job contract (and client payment) after all expenses have been subtracted, are also determined and displayed on this page. Another set of important financial information shown on this page is the commissions paid to the manager and salesperson(s).

If the user is an owner, an owner view information summary panel containing at-a-glance financial information of the job is also displayed. The owner view information panel may include the company overhead (amount and percentage), gross job profit (amount and percentage of total payment minus total expenses), total job commissions (amount and percentage), company share of the profit (gross job profit minus total job commissions), and total company job profit (company share of profit plus company overhead). The job management page further includes a notes section that provides information on any notation any user recorded for the job. The job management page also includes a “Users” section that lists all users or company personnel associated with this particular job. Further, the user may easily access images or copies of documents associated with this job, such as permits, blueprints, etc. Certain users with sufficient privileges may edit and/or delete data associated with these job entries.

The job management page uses a layout that clearly labels all the information and makes the data easy to see and understand. The payment, income, expenses, and profit information on the page are computed and populated by accessing stored data from the database. As financial data are updated, the computed information displayed on the job management page is also dynamically and automatically updated to reflect the most current information. Therefore, the job management page makes it easy for a user to see the latest financial status and current information of the construction job in a clear and concise manner.

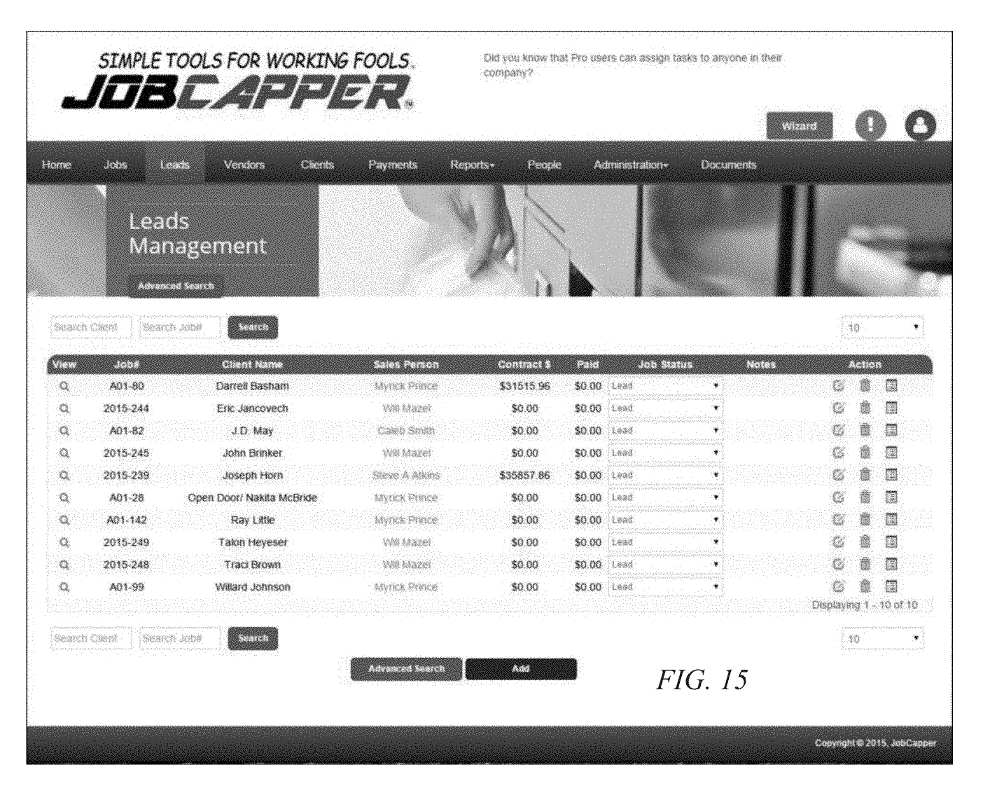

FIG. 15 is a screen shot of an exemplary embodiment of a job leads listing for the construction project management system and method according to the teachings of the present disclosure. A “job lead” is one in which a potential new client has been identified, and additional follow-up by a sales manager and/or salesperson is needed to secure the contract. As new jobs are entered into the system, a status is indicated for each job. The job leads module is operable to identify and display all the jobs that have a “lead” as the job status. The job leads management page provides a listing of potential jobs along with the client information and assigned salesperson names so that the information is easy to access. If available, the contract amount for the project is also displayed. The job leads management page makes it easy for a sales manager or salesperson to see leads that require further attention so that contracts may be finalized and secured.

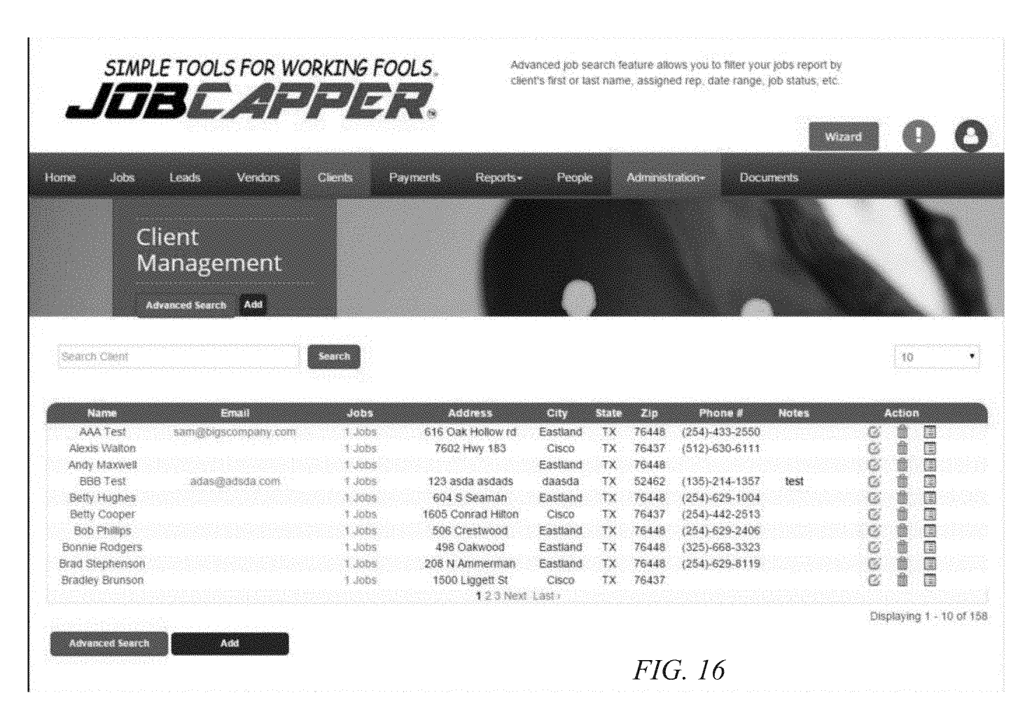

FIG. 16 is a screen shot of an exemplary embodiment of a client listing for the construction project management system and method 10 according to the teachings of the present disclosure. The client management page provides a listing of all clients stored in the system. The listing provides the client name, email address, physical address, telephone number, the number of jobs, and associated notes. New clients can be easily added from this page, and searching using the client name or advanced search with additional criteria is available. Certain users with sufficient privileges may edit and/or delete data associated with these client entries.

FIG. 17 is a screen shot of an exemplary embodiment of a people listing for the construction project management system and method 10 according to the teachings of the present disclosure. The people management page provides a listing of all company personnel who have been given a “key” so that they may access certain subsets of company data in the system. In this listing, the name, email address, physical address, telephone number, and type of personnel (i.e., role) are shown. The list may be modified or filtered to only show certain type(s) of personnel. For example, a user may select salespersons and insurance adjusters to display only those users that have these selected roles. As noted above, a person may have more than one role within the company. Advanced search capability is provided. Certain users with sufficient privileges may edit and/or delete data associated with these people entries.

FIG. 18 is a screen shot of an exemplary embodiment of a people management module for the construction project management system and method 10 according to the teachings of the present disclosure. When a specific person displayed on the people listing page (FIG. 17) is selected, more detailed information about that person is displayed such as shown in FIG. 18. In addition to the name and contact information, the financial arrangement this person has with the company, such as commission percentage and draws are also provided on this page. Certain users with sufficient privileges may edit and/or delete data associated with a personnel's profile page.

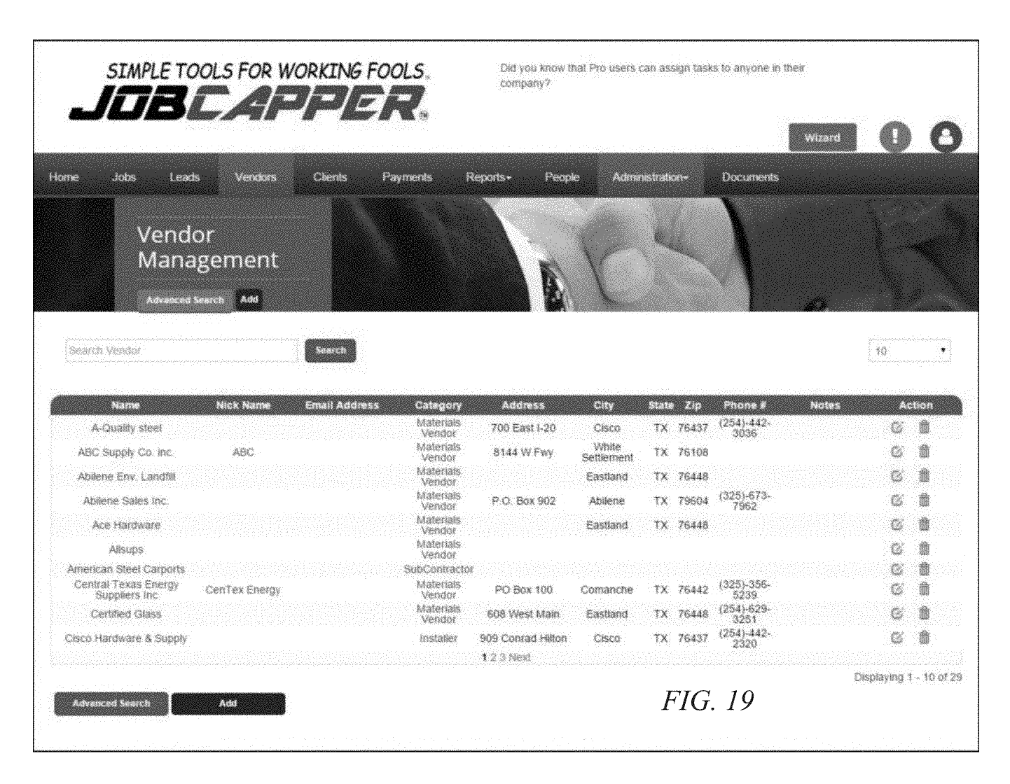

FIG. 19 is a screen shot of an exemplary embodiment of a vendor listing for the construction project management system and method 10 according to the teachings of the present disclosure. Vendors are individuals or companies that provide and sell construction materials and other supplies to the company. In this listing, the name, email address, physical address, telephone number, and type of vendor are shown. When a specific vendor displayed in the listing is selected, more detailed information about that vendor is displayed. Certain users with sufficient privileges may edit and/or delete data associated with a vendor's profile page.

FIG. 20 is a screen shot of an exemplary embodiment of a payment listing for the construction project management system and method 10 according to the teachings of the present disclosure. The payments page accesses the database for payment information and displays the information on this page in an easy to see and understand format. The payments page provides information on the payments received and paid out, including the job number of the job associated with the payment, the client name, the payor name, the payment amount, check number, and any notes associated with the payment. The displayed list is searchable by client name and/or job number. Advanced searching with additional criteria can be performed. A user may also add payments by clicking on the “Add” icon on this page. Certain users with sufficient privileges may edit and/or delete data associated with a payment.

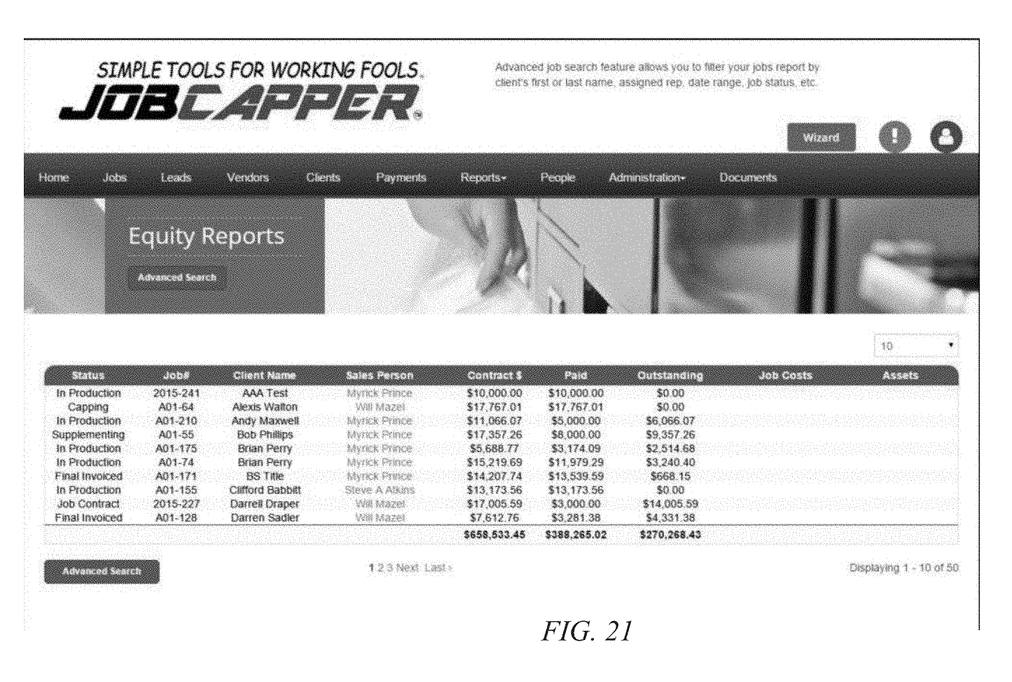

FIG. 21 is a screen shot of an exemplary embodiment of an equity report listing for the construction project management system and method 10 according to the teachings of the present disclosure. The equity report page gives the user a quick at-a-glance view of the status and financial data of jobs. As shown in FIG. 21, the contract amount, paid amount, and outstanding amounts for each job is shown. Further a total tally for each amount is provided. Using this page, a user can quickly see which job(s) require additional follow-up or attention to collect outstanding amounts.

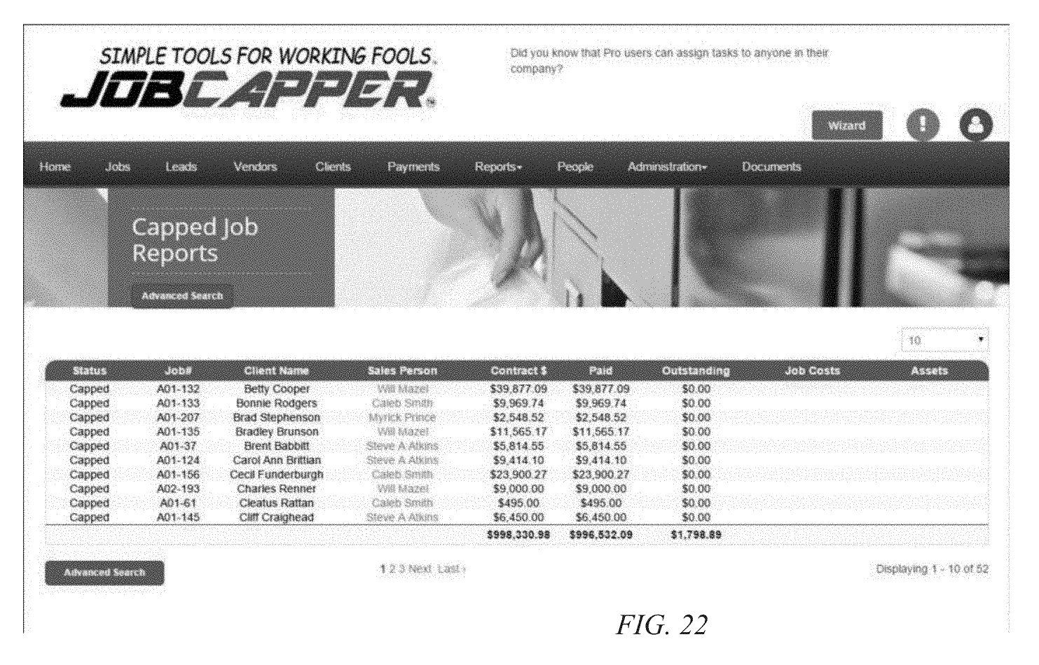

FIG. 22 is a screen shot of an exemplary embodiment of a capped job listing for the construction project management system and method 10 according to the teachings of the present disclosure. A number of online reports are available to the users, including an online report that lists all capped jobs for the company. A capped job is a job in which final accounting of all invoices and payments have been accounted for so that the job is officially done. As shown in FIG. 22, the contract amount, paid amount, and outstanding amounts for each capped job is shown. Further a total tally for each amount is provided.

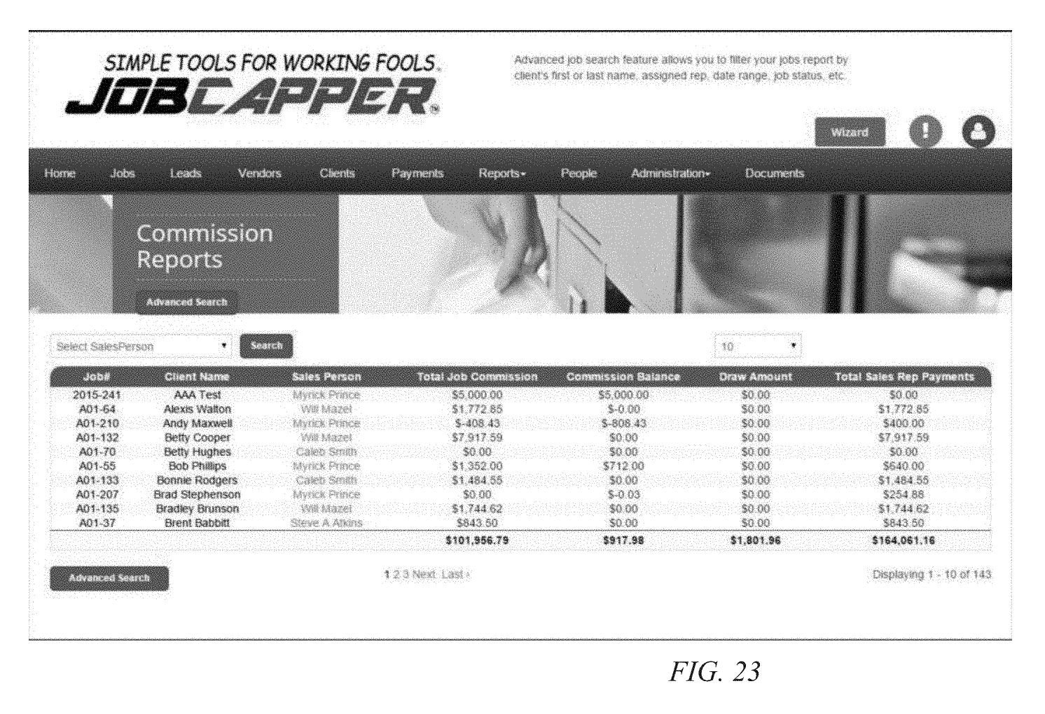

FIG. 23 is a screen shot of an exemplary embodiment of a commission report listing for the construction project management system and method 10 according to the teachings of the present disclosure. A number of online reports are available to the users, including an online report that lists company personnel and their commissions, including the total commission, commission balance, draw amount, and total commission payments. As shown in FIG. 23, the user may select a particular salesperson to display all commission information related to the selected person. The list is also searchable. Further a total tally for each amount is provided.

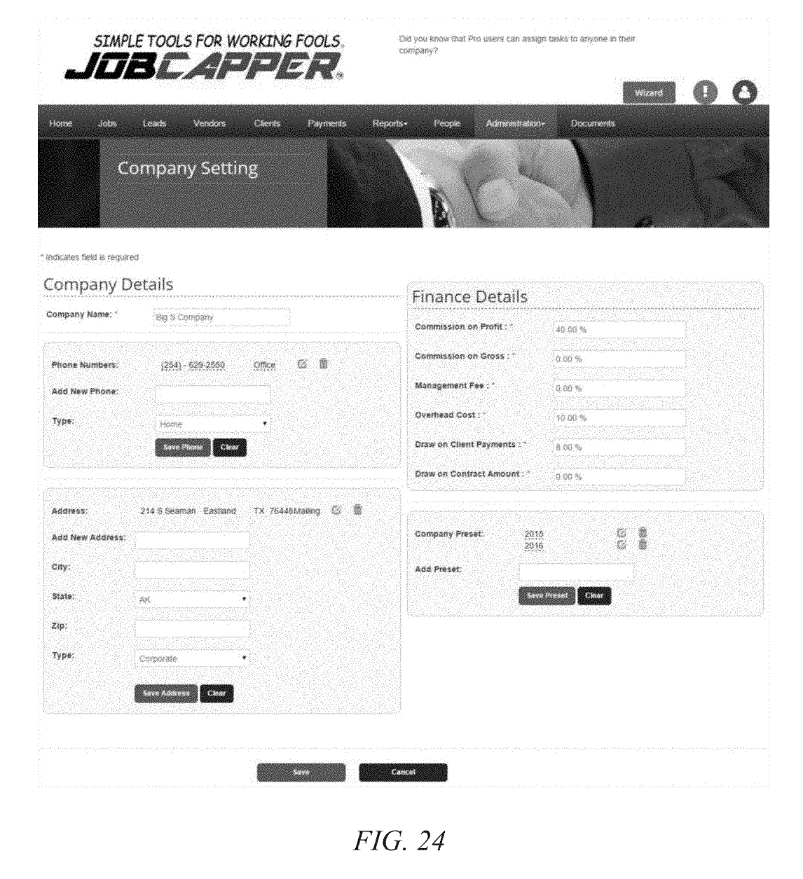

FIG. 24 is a screen shot of an exemplary embodiment of a company profile management module for the construction project management system and method 10 according to the teachings of the present disclosure. The company profile page gives the user the ability to enter information related to the company, including company name, telephone number(s), address, and finance details. The finance details set the commission percentages for salespeople, management fee percentage, overhead for the company, and how the commission payments are calculated (from profit or gross). Additionally, the financial arrangement for the company may include a specification that the company pays out draws to the salespeople and/or managers based on client payment and/or contract amount.

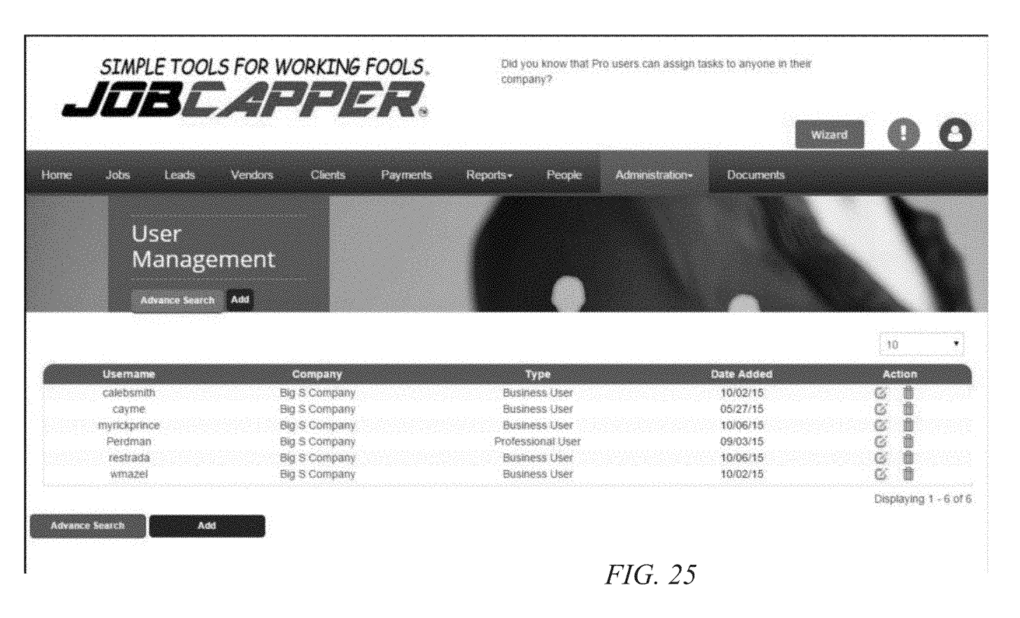

FIG. 25 is a screen shot of an exemplary embodiment of a user listing for the construction project management system and method 10 according to the teachings of the present disclosure. The user management module accesses the database and extracts user information related to a specific company for display. The information displayed include user name, company name, type of user (e.g., business or professional user), and the date added to the system. Certain users with sufficient privileges may edit and/or delete data associated with a user.

FIG. 26 is a screen shot of an exemplary embodiment of a privileges module for the construction project management system and method according to the teachings of the present disclosure. Certain users with sufficient privileges may edit and set the data access privileges associated with each company role, company, and user. In the example shown in FIG. 26, the user may selectively set the type of access, e.g., view, add, edit, delete, users with a salesperson role may have for data items on each page on the website. The setting becomes the privileges default for the salesperson role for the company.

FIG. 27 is a screen shot of a further exemplary embodiment of a privileges module for the construction project management system and method 10 according to the teachings of the present disclosure. Although a company may set default privileges for each type of company role, the privileges module allows the company to deviate the privileges setting from default for particular users. The default/custom switch in the right-most column enables the user to immediately ascertain which users have custom privileges instead of the default setting.

Accordingly, by using the construction project monitoring system and method described herein, a company owner or executive can easily access financial and personnel data that are important to the bottom line of the company. The owner or executive can easily see the status of certain construction jobs, deduce the company profits and expenses, and monitor the performance of the company's salespeople.

The features of the present invention which are believed to be novel are set forth below with particularity in the appended claims. However, modifications, variations, and changes to the exemplary embodiments described above will be apparent to those skilled in the art, and the construction project monitoring system and method described herein thus encompasses such modifications, variations, and changes and are not limited to the specific embodiments described herein.

What is claimed is:

1. A construction project management system, comprising:
a secure database for storing construction project data and coupled to and accessible via a global computer network;
a web server hosting a plurality of web pages and coupled to the secure database to retrieve and store construction project data;
the plurality of web pages having logic configured for providing an authorized user associated with a construction company selective access to data stored in the secure database, computing financial data, and displaying construction project data in a concise manner, the web pages comprising:
a dashboard web page configured to display an activity feed section listing changes made by company personnel to the construction project data of the construction company stored in the secure database;
a client management web page configured to provide access to information about clients of the construction company stored in the secure database;
a people management web page configured to provide access to information about company personnel of the construction company stored in the secure database;
a job management web page configured to provide access to financial and status information about construction jobs of the construction company stored in the secure database; and
a privileges management web page configured to provide access to data access privilege settings of company personnel.

2. The system of claim 1, wherein the dashboard web page further displays a summary section providing a numerical status of a plurality of activities.

3. The system of claim 1, wherein the dashboard web page further displays a tasks section providing a list of tasks assigned to the authorized user.

4. The system of claim 1, wherein the client management web page comprises logic configured to receive data edits, adds, and deletes to client data by the authorized user having edit, add, and delete privileges.

5. The system of claim 1, wherein the people management web page comprises logic configured to receive data edits, adds, and deletes to company personnel data by the authorized user having edit, add, and delete privileges.

6. The system of claim 5, wherein the people management web page further comprises logic configured to receive data edits, adds, and deletes to profile data and user role of company personnel by the authorized user having edit, add, and delete privileges.

7. The system of claim 1, wherein the job management web page comprises logic configured to receive data edits, adds, and deletes to jobs data by the authorized user having edit, add, and delete privileges.

8. The system of claim 1, wherein the privileges management web page comprises logic configured to receive data edits, adds, and deletes to privileges settings by the authorized user having edit, add, and delete privileges.

9. The system of claim 1, wherein the job management web page further comprises:
a client payment section configured to display one or more payments received from a client for a construction job;
a materials payment section configured to display one or more payments paid for purchase of materials for the construction job;
a labor payment section configured to display one or more payments paid for labor for the construction job;
a sales commission section configured to display one or more payments paid for sales commission;
a job income section configured to access the secure database, and determine and display a contract amount for the construction job, total client payments for the construction job, and a contract balance for the construction job;
a job expenses section configured to access the secure database, and determine and display a labor total amount, a materials total amount, company overhead amount, and a total job expenses amount; and
a job profits section configured to access the secure database, and determine and display a total company profit amount.

10. The system of claim 1, wherein the job management web page further comprises an owner view section configured to access the secure database, and determine and display for the authorized user company overhead amount and percentage of contract total, gross job profit amount and percentage of contract total, total job commission amount and percentage of contract total, company share of profit amount, and total company job profit amount.

11. The system of claim 1, wherein the plurality of web pages further comprises a leads management web page providing the authorized user access to information about job leads of the construction company stored in the secure database.

12. The system of claim 1, wherein the plurality of web pages further comprises a vendor management web page providing the authorized user access to information about vendors of the construction company stored in the secure database.

13. The system of claim 1, wherein the plurality of web pages further comprises a payments management web page providing the authorized user edit and viewing access to information about payments of the construction company stored in the secure database.

14. The system of claim 1, wherein the plurality of web pages further comprises an equity report web page providing the authorized user access to financial information about construction projects of the construction company stored in the secure database.

15. The system of claim 1, wherein the plurality of web pages further comprises a capped job report web page providing the authorized user access to financial information about completed construction projects of the construction company stored in the secure database.

16. The system of claim 1, wherein the plurality of web pages further comprises a commission report web page providing the authorized user access to commissions paid for the construction projects of the construction company stored in the secure database.

17. The system of claim 1, wherein the privileges management web page further comprises a default privileges web page providing the authorized user access to edit and set default privileges for at least one user role.

18. The system of claim 1, wherein the privileges management web page further comprises a custom privileges web page providing the authorized user access to edit and set custom privileges for at least one user.

19. A method of monitoring construction project information, comprising:
providing a plurality of web pages having logic configured for providing an authorized user associated with a construction company selective access to data stored in a secure database, including receiving construction project data, storing the construction project data, computing construction project financial data, and displaying construction project data in a concise manner;
displaying, by a dashboard web page, an activity feed section listing changes made by company personnel to the construction project data of the construction company stored in the secure database;
providing, by a client management web page, access to information about clients of the construction company stored in the secure database;
providing, by a people management web page, access to information about company personnel of the construction company stored in the secure database;
providing, by a job management web page, access to financial and status information about construction jobs of the construction company stored in the secure database; and
providing, by a privileges management web page, access to data access privilege settings of company personnel.

20. The method of claim 19, further comprising displaying, by the dashboard web page, a summary section providing a numerical status of a plurality of activities.

21. The method of claim 19, further comprising displaying, by the dashboard web page, a tasks section providing a list of tasks assigned to the authorized user.

22. The method of claim 19, further comprising receiving, by the client management web page, data edits, adds, and deletes to client data from the authorized user having edit, add, and delete privileges.

23. The method of claim 19, further comprising receiving, by the people management web page, data edits, adds, and deletes to company personnel data from the authorized user having edit, add, and delete privileges.

24. The method of claim 23, further comprising receiving, by the people management web page, data edits, adds, and deletes to profile data and user role of company personnel from the authorized user having edit, add, and delete privileges.

25. The method of claim 19, further comprising receiving, by the job management web page, data edits, adds, and deletes to jobs data from the authorized user having edit, add, and delete privileges.

26. The method of claim 19, further comprising receiving, by the privileges management web page, data edits, adds, and deletes to privileges settings from the authorized user having edit, add, and delete privileges.

27. The method of claim 19, further comprising:
displaying, on the job management web page, a client payment section configured to provide one or more payments received from a client for a construction job;
displaying, on the job management web page, a materials payment section configured to provide one or more payments paid for purchase of materials for the construction job;
displaying, on the job management web page, a labor payment section configured to provide one or more payments paid for labor for the construction job;
displaying, on the job management web page, a sales commission section configured to provide one or more payments paid for sales commission;
displaying, on the job management web page, a job income section configured to access the secure database, and determine and display a contract amount for the construction job, total client payments for the construction job, and a contract balance for the construction job;
displaying, on the job management web page, a job expenses section configured to access the secure database, and determine and display a labor total amount, a materials total amount, company overhead amount, and a total job expenses amount; and
displaying, on the job management web page, a job profits section configured to access the secure database, and determine and display a total company profit amount.

28. The method of claim 19, further comprising displaying, on the job management web page, an owner view section configured to access the secure database, and determine and display for an authorized user company overhead amount and percentage of contract total, gross job profit amount and percentage of contract total, total job commission amount and percentage of contract total, company share of profit amount, and total company job profit amount.

29. The method of claim 19, further comprising displaying a leads management web page configured to provide the authorized user access to information about job leads of the construction company stored in the secure database.

30. The method of claim 19, further comprising displaying a vendor management web page configured to provide the authorized user access to information about vendors of the construction company stored in the secure database.

31. The method of claim 19, further comprising displaying a payments management web page configured to provide the authorized user edit and viewing access to information about payments of the construction company stored in the secure database.

32. The method of claim 19, further comprising displaying an equity report web page configured to provide the authorized user access to financial information about construction projects of the construction company stored in the secure database.

33. The method of claim 19, further comprising displaying a capped job report web page configured to provide the authorized user access to financial information about completed construction projects of the construction company stored in the secure database.

34. The method of claim 19, further comprising displaying a commission report web page configured to provide the authorized user access to commissions paid for the construction projects of the construction company stored in the secure database.

35. The method of claim 19, further comprising displaying a default privileges web page configured to provide the authorized user access to edit and set default privileges for at least one user role.

36. The method of claim 19, further comprising displaying a custom privileges web page configured to provide the authorized user access to edit and set custom privileges for at least one user.
